(19) United States
(12) Patent Application Publication
(10) Pub. No.: US 2009/0285623 A1
(43) Pub. Date: Nov. 19, 2009

(54) LOCKING RING METAL

(76) Inventor: Paul Whaley, Pevely, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/123,139

(22) Filed: May 19, 2008

(51) Int. Cl. B42F 13/26

(52) U.S. Cl. 402/38

(57) ABSTRACT

A locking ring metal (10) having twist-lok rings (12-16). Each binder ring comprises a pair of binder ring halves (12a-12b, 14a-14b, 16a-16b) with one end of each ring half interlocking with the one end of the other ring half, when the binder ring is closed, so to close the binder ring. A pair of frames (18, 20), mounted beneath a cover (22) of the ring metal, extend generally parallel to each other substantially the length of the metal. The other end (12c-12d, 14c-14d, 16c-16d) of each ring half is attached to a respective one of the frames so movement of the frames relative to each other affects opening of the binder ring. A trigger mechanism (26) operated by a user of the binder moves one of the frames relative to the other frame which is fixed in place and does not move. Movement of the frame is longitudinally of the metal and this movement spatially separates the interlocking ends of the binder ring halves and opens the binder ring. Springs (30-30c) have their respective ends secured to opposite sides of the cover, on the underside of the cover, below the frames. The springs exert a pivoting force on the frames, once the interlocking ends of the binder end halves are separated, to urge the frames to pivot in a binder ring opening direction.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

In U.S. Pat. No. 5,660,490, there is described a binder ring metal commonly referred to as a “twist-lok” metal. An advantage of this type metal is that it is relatively easy for a user to open by applying finger pressure to respective halves of a binder ring, typically near the respective ends of the ring halves where they join together, to close the metal. The user then moves his or her fingers in a rotary or twisting manner to separate the ends of the halves. The opposite ends of the ring halves are connected to separate leaves which extend side-by-side beneath a cover portion of the metal. The leaves have swedges which are angled with respect to the leaves and the twisting movement of the upper portion of the ring halves causes the leaves to sufficiently flex so that an over center toggling action occurs and the binder rings remain open after the finger pressure is released.

A problem with previous twist-lok metals has been that they are prone to open when a binder in which they are installed is accidentally dropped. If a binder falls off a table, or is bumped out of a person's hands while they are carrying the binder, it often occurs that one or more of the binder rings spring apart, opening the binder. The person then must retrieve the binder and re-close the rings, hopefully without having lost any pages out of the binder. The present invention is directed to an improved twist-lok ring metal which is still easy to open, but which now does not inadvertently open when dropped, bumped, or otherwise subjected to a force.

More recently, attempts have been made to improve the construction of these type metals. See, for example, U.S. application publication 2008/0089736. However, further improvements are still required to insure that twist-lok binder rings stay tightly closed when an otherwise opening force is accidentally applied.

### BRIEF SUMMARY OF THE INVENTION

The present disclosure is directed a locking ring metal having twist-lok rings. A plurality of twist-lok type binder rings are spaced along the length of the metal. Each binder ring comprises a pair of binder ring halves with one end of each ring half interlocking with the corresponding end of the other ring half, when the binder rings are closed, to close the respective binder rings. A pair of frames extend generally parallel to each other substantially the length of the metal. The other end of each ring half of each binder ring is attached to a respective one of the frames for pivotal movement of the frames relative to each other affecting opening of the binder rings. One of the frames is movable longitudinally with respect to the other frame which cannot move longitudinally. The ring metal also includes a cover beneath which the frames are installed. A trigger is installed at one end of the ring metal. Movement of the trigger moves the movable frame relative to the other frame to separate the interlocking ends of the binder ring halves. A spring has respective ends which are secured to opposite sides of the cover, on the underside thereof, and below the frames. The springs exert a force on the frames, after the interlocking ends of the binder end halves are separated, to urge the frames to pivot in a binder ring opening direction.

In one embodiment of the invention, each frame includes a tab contacted by each spring for the spring to exert the binder ring opening force on the frame. In a second embodiment of the invention, the spring is a circular spring looped about the tabs with the force exerted by the spring on the frames urging the frames toward a binder ring open position once the interlocking ends of the binder ring are separated.

It is an advantage of this ring metal construction that the binder rings cannot be inadvertently or accidentally opened if the binder is dropped or bumped.

Importantly, it is a further feature of the ring metal of the present invention to lock the movable frame member in place when the binder rings are open. This is done using a tab formed or attached to the movable frame or a ring metal cover and a slot formed on the other of the two components. The tab is received in the slot as the binder rings are opened by pivoting movement of the longitudinally movable frame member and prevents subsequent longitudinal movement of the movable frame member until the binder rings are substantially closed.

It is a feature of the present invention to provide an easy to open ring metal, but one in which, when the twist-lok rings are closed, sufficient force is exerted on the rings to keep them closed.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a perspective view of a ring binder with a ring metal of the present invention;

FIG. 2 is a perspective view of the metal with the binder rings in their close, locked position;

FIG. 3 is a perspective view similar to FIG. 2 with the binder rings open;

FIG. 4 is an end elevation view of the ring metal with the binder rings closed;

FIG. 5 is a side elevation view of the ring metal with the binder rings closed;

FIG. 6 is a top plan view of the ring metal with the binder ring closed;

FIG. 7 is top plan view of the ring metal with the binder ring open;

FIG. 8 is a perspective view of the underside of the ring metal with the binder rings closed;

FIG. 9A is a partial bottom plan view of the trigger end ring metal with the binder rings open, and FIG. 9B is a partial plan view of the other end of the ring metal with the binder rings open;

FIG. 10 is a full bottom plan view of the ring metal with the binder rings open;

FIG. 11 is a bottom plan view of a second embodiment of the ring metal with the binder rings open;

FIG. 12 is a plan view of a section of the ring metal, when the binder rings are open, illustrating the offset between the respective ring halves;

FIG. 13 is a plan view of a section of the ring metal illustrating a downwardly extending tab formed in the top portion of the shield;

FIG. 14 is a plan view of a section of the underside of the ring metal illustrating the projection of the downwardly extending tab through a slot formed in one of the frames shield;

FIG. 15 is a perspective view of a portion of the underside of the ring metal cover illustrating a tab extending from the underside of the cover for blocking movement of a movable frame when the binder rings are open;

FIG. 16 is a perspective of a portion of the movable frame showing the corresponding slot in which the tab is received; and,

FIG. 17 is a perspective view of a portion of the ring metal cover illustrating a tab extending from the underside of the cover through a slot in the cover for blocking movement of a movable frame when the binder rings are open.

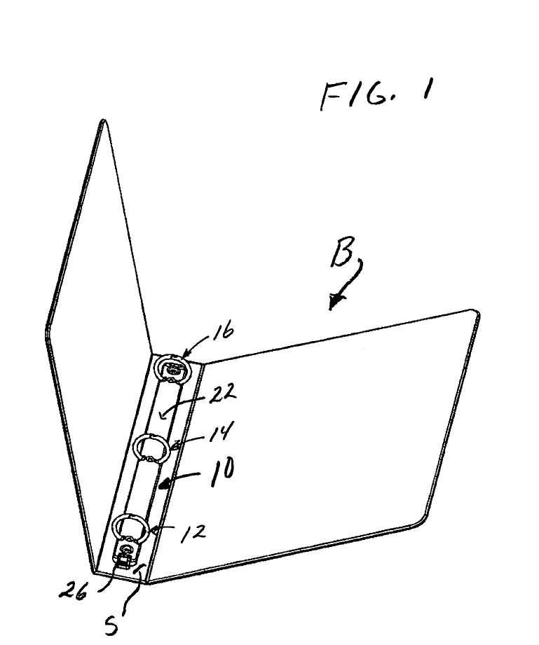

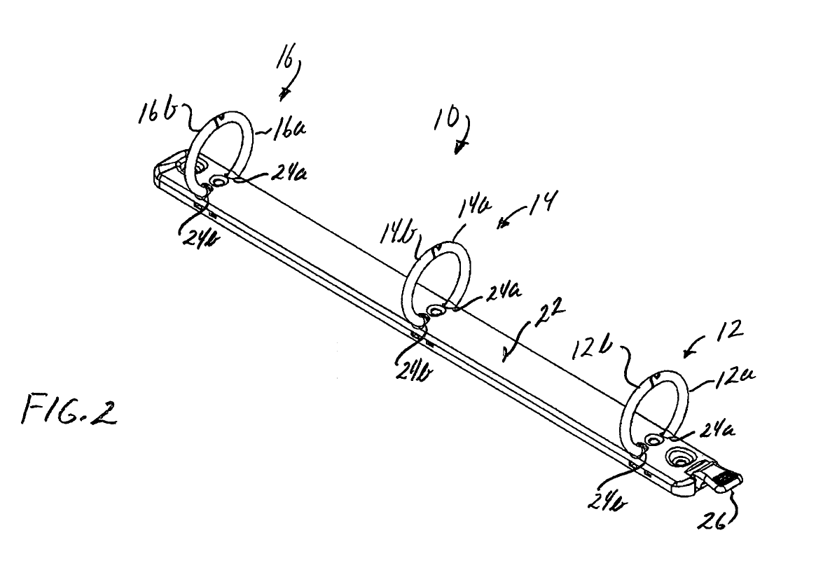

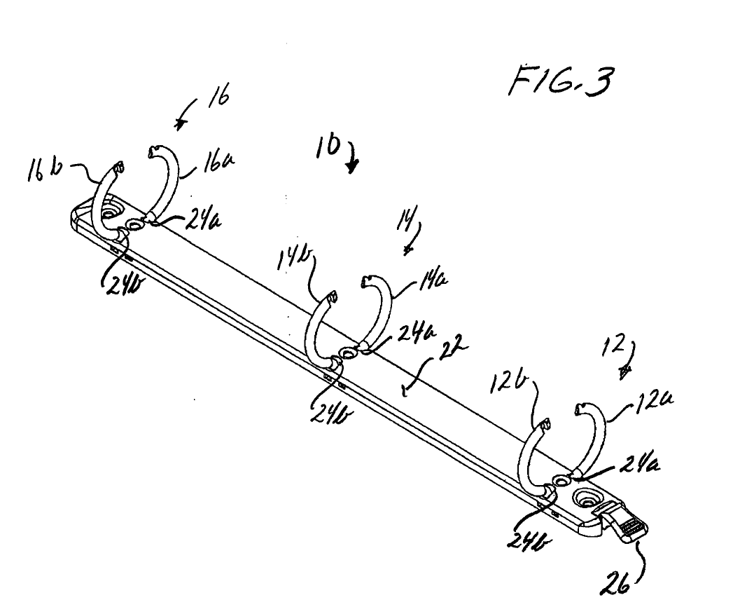

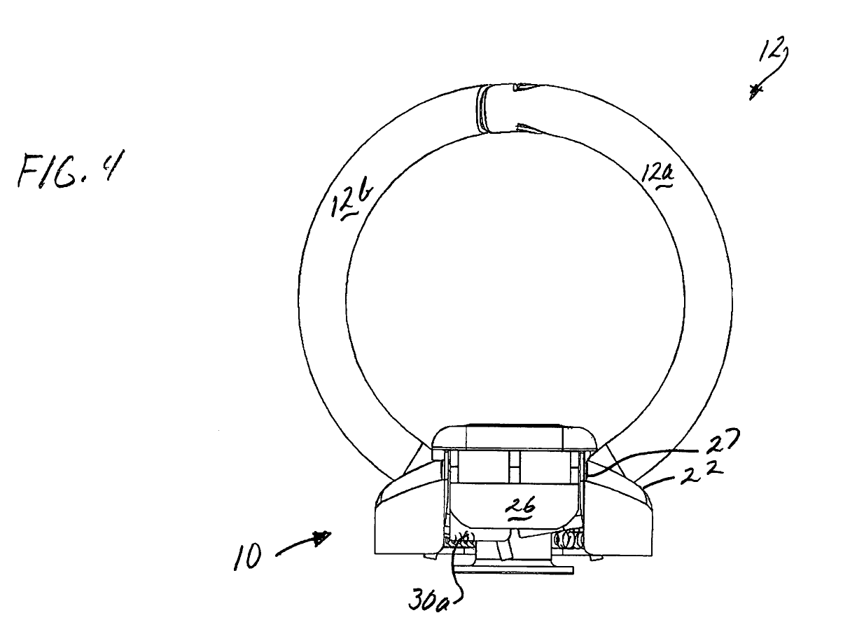

Corresponding reference characters indicate corresponding parts throughout the several views of the drawings.

### DETAILED DESCRIPTION OF THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

The present invention is directed at first, making it easier for a person to open a “twist-lok” metal. But second, and at the same time, the present invention substantially prevents the binder rings from being inadvertently or accidentally opened for one of the above noted reasons.

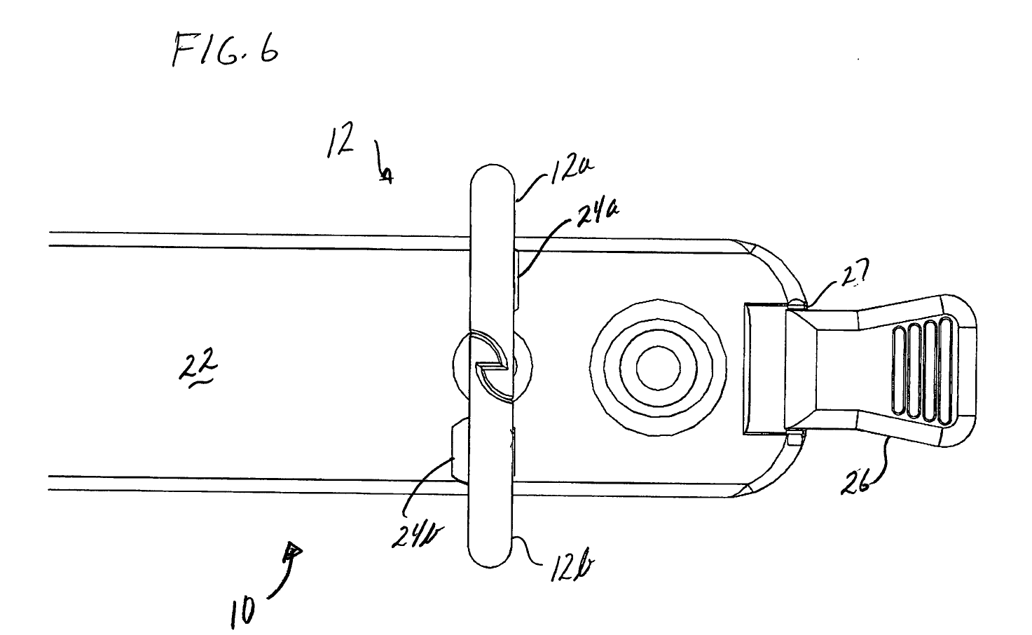

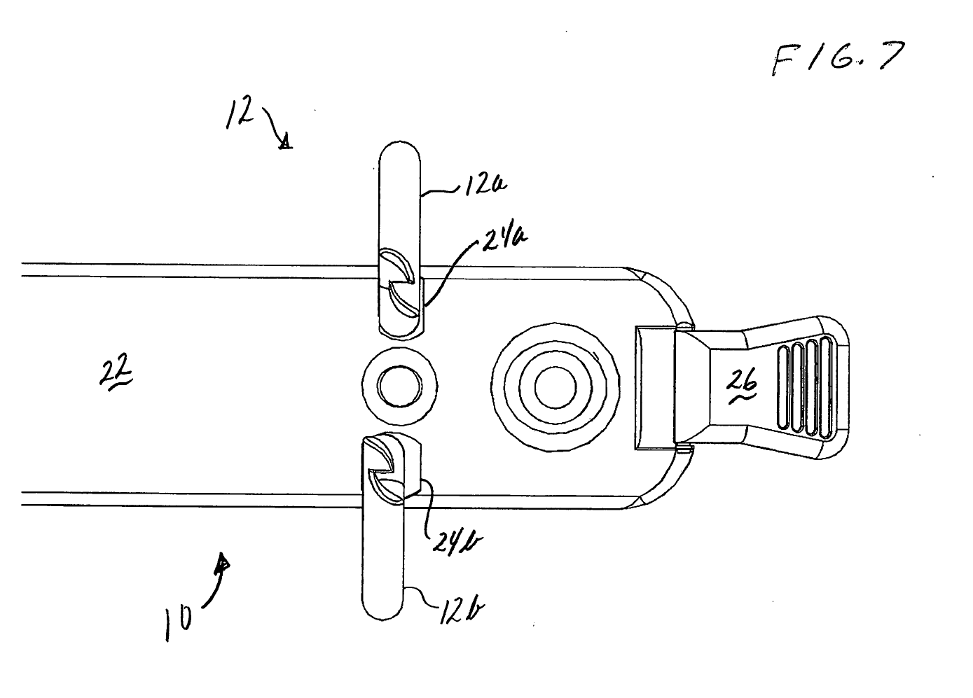

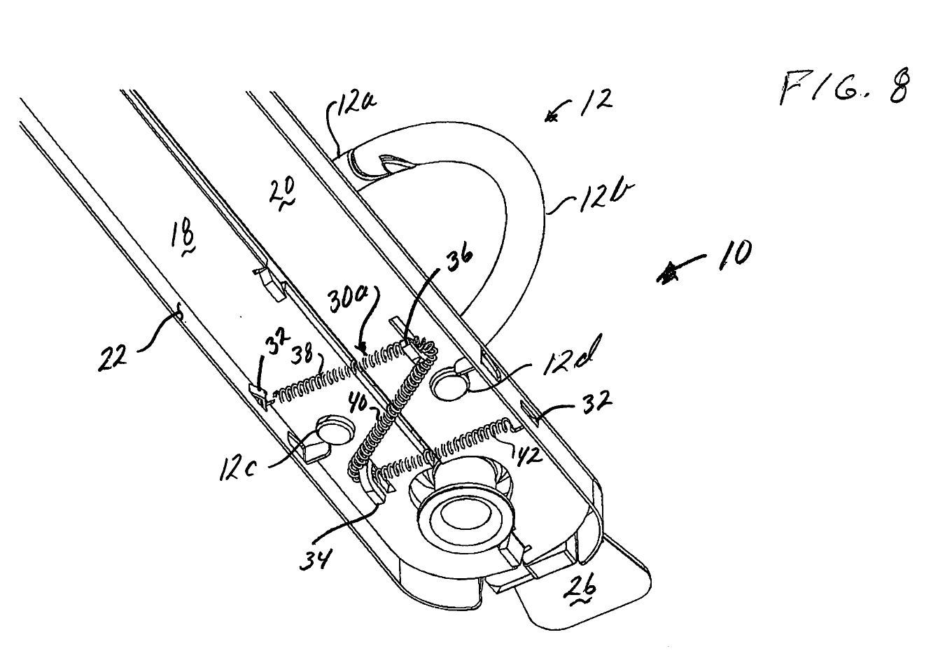

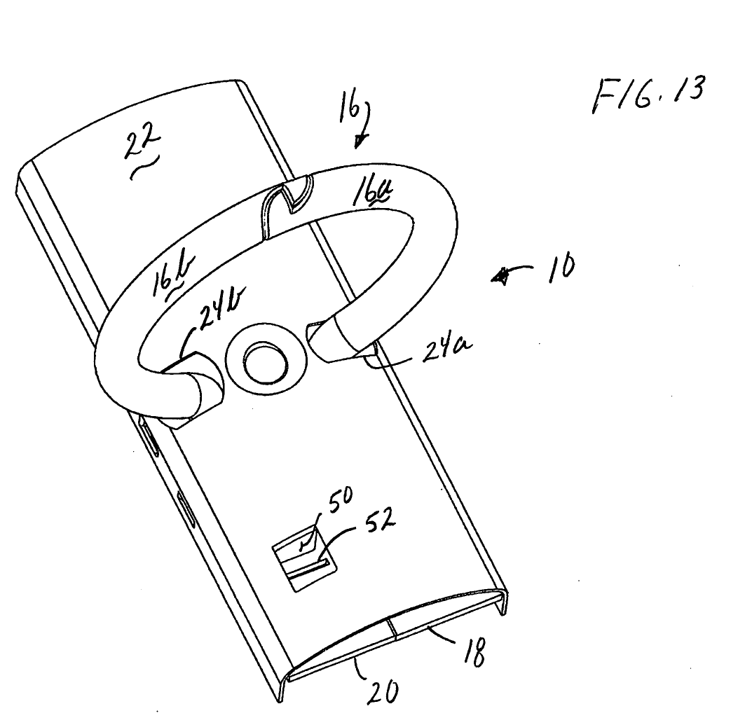

Referring to the drawings, a binder ring metal 10 of the present invention is for installation, for example, in the spine section S of a binder B for holding hole punched sheets of paper or the like. Those skilled in the art will understand that ring metal 10 can be installed in other ways in different type binders. Ring metal 10 is a “twist-lok” metal having a plurality of binder rings indicated generally 12, 14, and 16. The metal may have more, or fewer, rings without departing from the scope of the invention. Each ring is comprised of two ring halves 12a-12b, 14a-14b, and 16a-16b respectively. As is known in the art, the outer ends of twist-lok ring halves are formed or shaped so that they interlock when the rings are closed. This is best shown, for example, in FIGS. 6, 8, and 13.

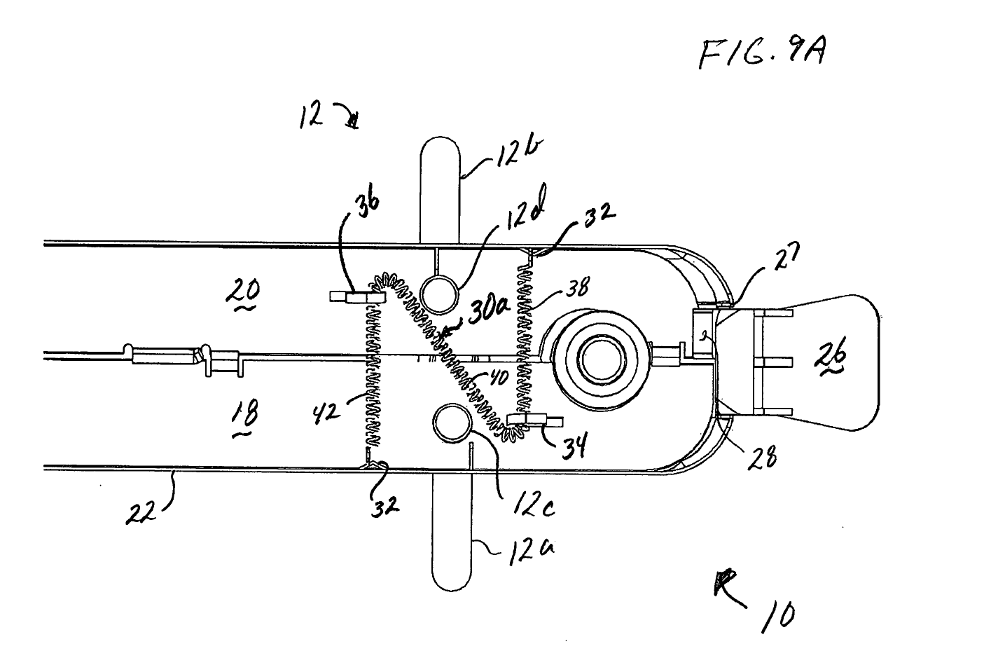

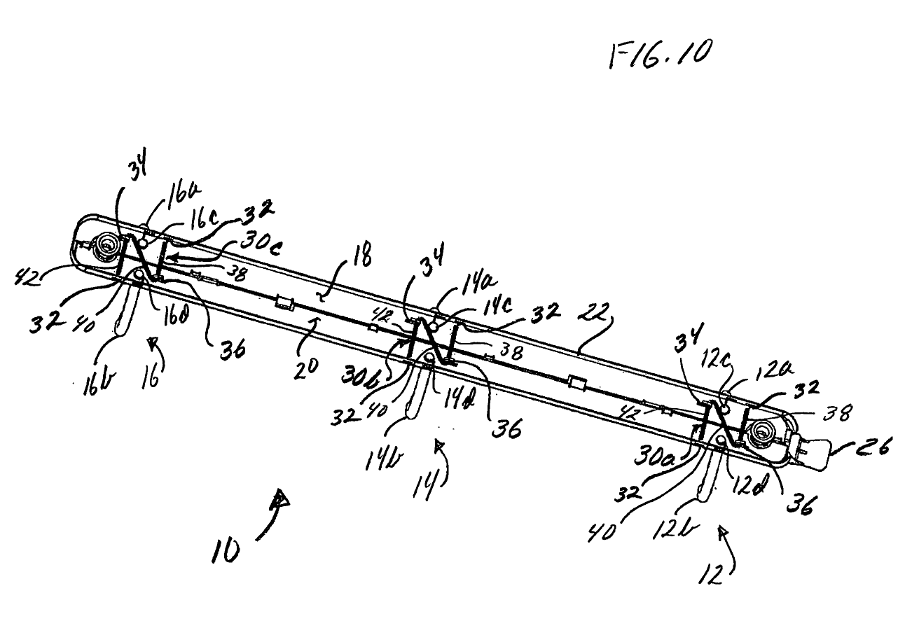

As shown in FIGS. 8-11, one end 12c, 12d, 14c, 14d, and 16c, 16d of the respective ring halves are attached to a frame or leaf 18, 20. The frames are rectangular plates which extend parallel to each other in a side-by-side relationship substantially the length of the ring metal. A cover or shield 22 fits over the plates so they are located on the underside of the cover. Openings 24a, 24b are formed in the cover for the upper portion of the binder ring halves to project through the cover. As particularly shown in FIG. 10, and as described hereinafter, the openings 24b are wider than the openings 24a. Importantly, and unlike other ring metals, cover 22 is made of a conventional cover material. However, the material from which cover 22 is fabricated in not crimped in such a way as to act as spring as is conventional ring metal covers. That is, the cover does not have sufficient resiliency to function as a spring which exerts a force on the frames 18, 20.

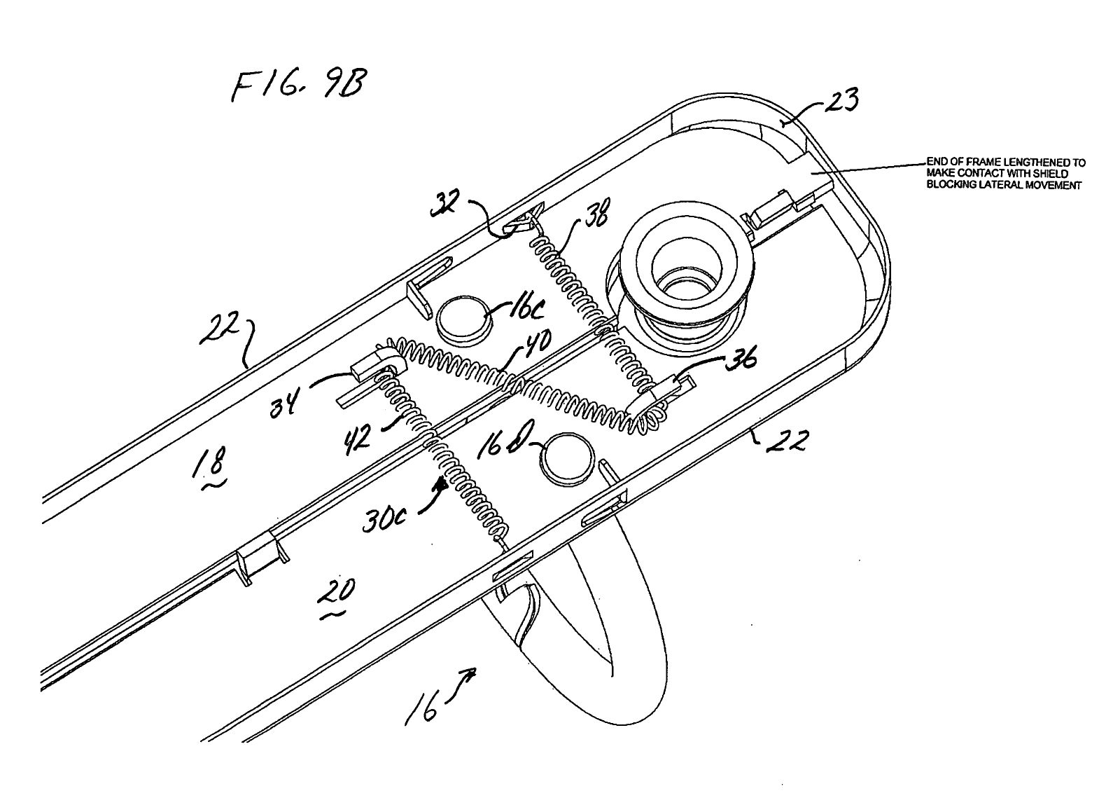

A trigger 26, located at one end of ring metal 10 is connected to frames 18, 20 for use by someone to open and close binder B. In this regard, the trigger mechanism includes a coil spring 27 and a bar 28 which connects to frame 20 so to push and pull the frame in a direction longitudinal to cover 22 and frame 18. Importantly, trigger 26 is not connected to frame 18 so as to move the frame longitudinally of ring metal 10, beneath cover 22. So, while both frames will pivot, as described hereinafter, to affect a rotary ring opening and closing movement of the binder ring halves, only frame 20 moves linearly or longitudinally; frame 18 does not so move. As shown in FIG. 9B, frame 18 is longer than frame 20 for this purpose. That is, frame 18 is so lengthened that the end of the frame abuts an end wall 23 of cover 22 opposite the trigger end of the ring metal.

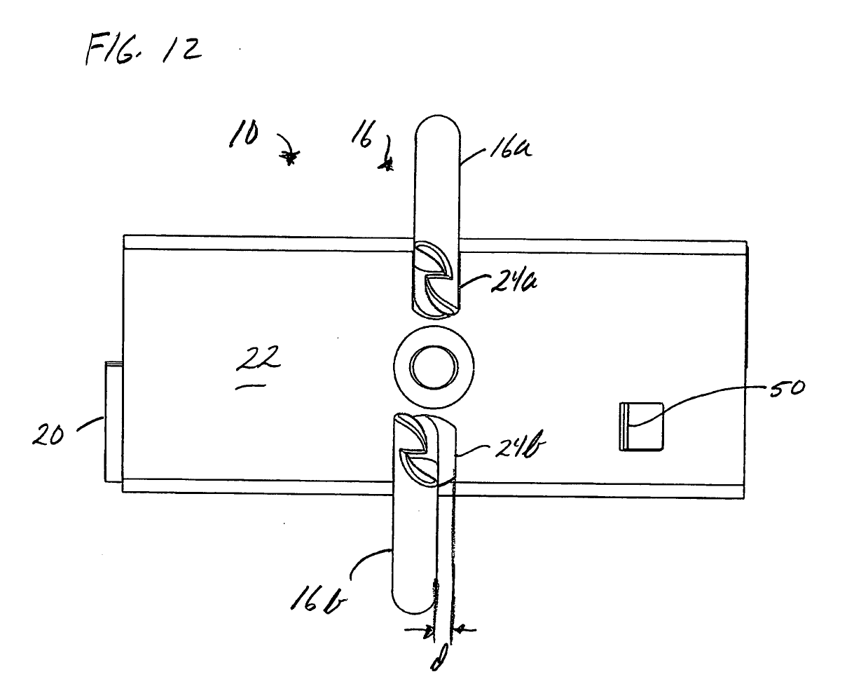

It will be understood by those skilled in the art that opening the binder rings 12-16 is two-step process. First, the interlocking ends of the binder ring halves must be spatially separated from each; and then, the ring halves of the respective binder rings are rotated away from each other. Operation of trigger 26 first moves frame 20 longitudinally or lengthwise along ring metal 10 so that it slides along underneath cover 22 a short distance. In this regard, frame 18 is considered a fixed frame, in that operation of trigger 26 does not significantly move this frame lengthwise along the ring metal. Rotation of trigger 26 does, however, significantly move frame 20 in a longitudinal direction. Referring to FIG. 12, this movement is indicated d, and is, for example, ⅛″. As shown in FIG. 12, this movement is sufficient to move binder ring half 16b a distance such that the interlocking end of this piece now is clear of the corresponding interlocking end of ring half 16a. The same is true of the respective binder ring halves 12b and 14b being moved the same distance so the interlocking end of these pieces now clear of the corresponding interlocking ends of respective ring halves 12a and 14a.

It will be understood by those skilled in the art that this longitudinal movement of frame 20 serves only to separate the interlocking ends of the ring metal halves from each other. It will also be understood by those skilled in the art that someone can also achieve the same effect by manually moving one of the ring halves 12b, 14b, or 16b longitudinally away from its corresponding ring half 12a, 14a, or 16a.

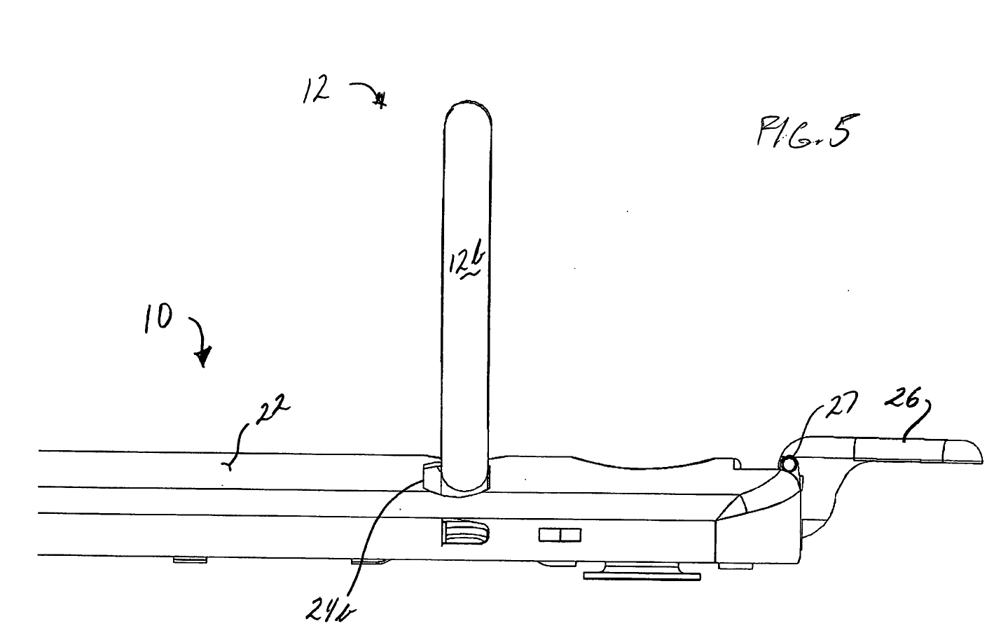

Ring metal 10 next includes a spring 30a-30c positioned adjacent a respective binder ring 12-16 on the underside of cover 22. This is as particularly shown in FIGS. 4 and 8-10. Ears 32 are formed on the underside of cover 22, on opposite sides of the cover, and each spring 30a-30c has its respective ends secured to opposite sides of the cover, below the frames, using these ears. Next, a tab 34 is formed on the underside of frame 18, as is a tab 36 on the underside of frame 20. The ears 32 along one side of cover 20 are offset from those on the opposite side of the cover. In addition, when binder B is closed, the respective tabs 34 are substantially directly across from the ears 32 adjacent frame 20; and the respective tabs 36 are substantially directly across from the ears 32 adjacent frame 18. Installation of the springs 30a-30c are such that a first leg 38 of each spring extends from the ear 32 on the side of the cover adjacent frame 18, across frame 18 to the tab 36 on frame 20. A next leg 40 of the spring extends diagonally across the frames to the tab 34 on frame 18. Finally, a leg 42 of the spring extends from the tab 34 on frame 18, across frame 20 to the ear 32 on the side of the cover adjacent frame 20. This spring installation results in a Z shaped configuration of the springs 30a-30c as shown in FIGS. 8-10.

In operation, once frame 20 has moved longitudinally of frame 18 so the interlocking ends of each binder ring are separated from each other, the respective springs 30a-30c take over and exert a force on the frames causing the frames to pivot in a binder ring opening direction. The resulting rotation of the frames now causes the outer ends of the binder ring halves to rotate away from each other, opening the binder.

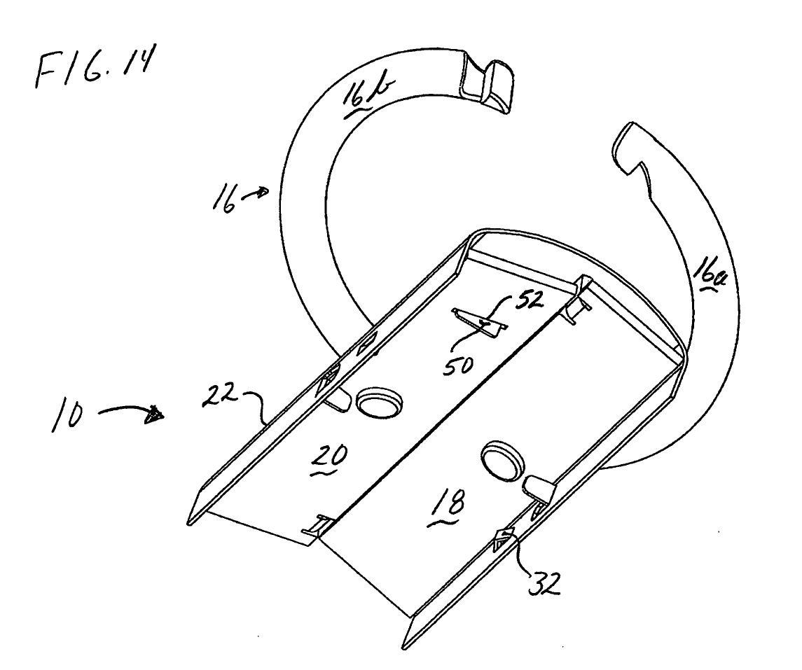

Referring to FIGS. 12-15, a tab 50 depends downwardly from the underside of cover 22. The tab is formed by cutting a flap in the top surface of the cover and pushing so that it extends downwardly from the top of the cover. Or, the tab can be a separate piece attached to the underside of the cover and extending downwardly from it. Regardless, the tab is formed or attached adjacent the location of a binder ring, as shown in the drawings. It will be understood that a separate tab 50 is located adjacent each binder ring. The tabs are formed (or attached) to one side of the cover above frame 20. A slot 52 is formed in frame 20 directly beneath the location of each tab 50; and, which the frames are pivoted to open the binder rings, the tabs extend through the corresponding slots 52 formed in the frame. This is as shown in FIG. 14.

Now, so long as the binder rings remain open, longitudinal movement of frame 20 is prevented or blocked by the tabs 50 in the slots 52. This maintains ring metal 10 in a binder ring open position. When the binder rings are subsequently closed, the frames are rotated in the opposite direction to that in which they were rotated to open the rings. However, for the greatest portion of this rotation of the frames, a portion of the tabs 50 will extend through the slots 52 so to continue to prevent longitudinal movement of frame 20. This means that frame 20 can only continue to rotate, not move longitudinally. However, as the interlocking ends of the respective binder ring halves come into registry with each other, frame 20 clears the tabs 50 so that the frame can now move longitudinally in the direction for the interlocking ends of the binder ring halves to interfit with each other and close binder B.

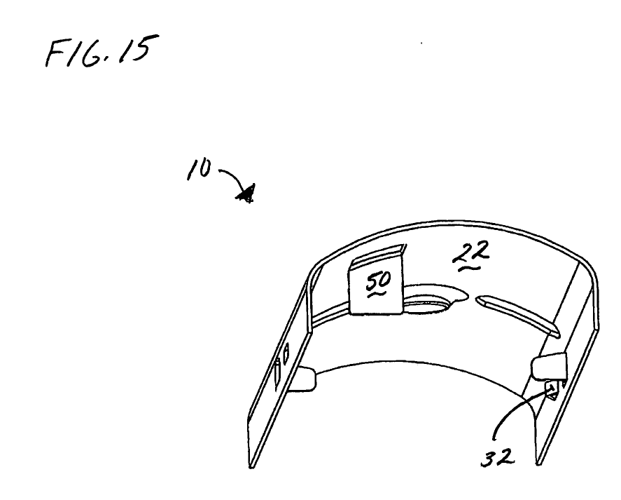

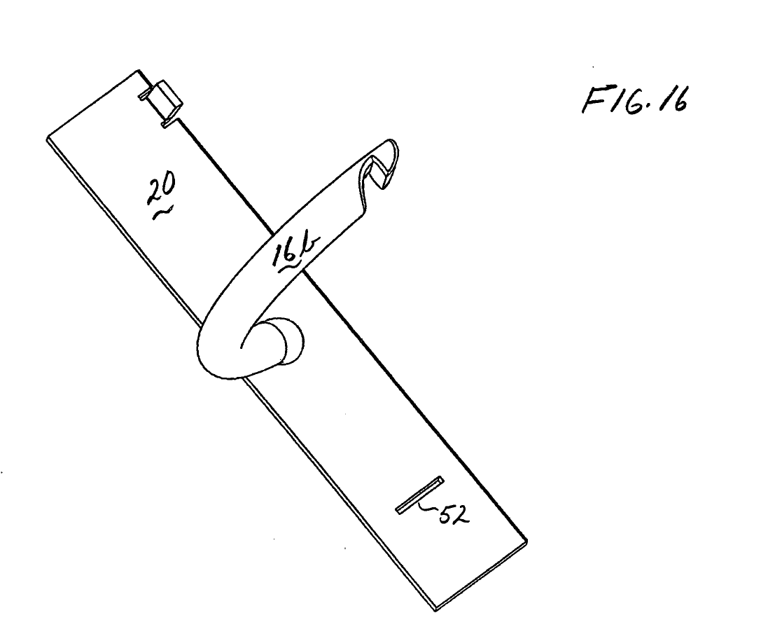

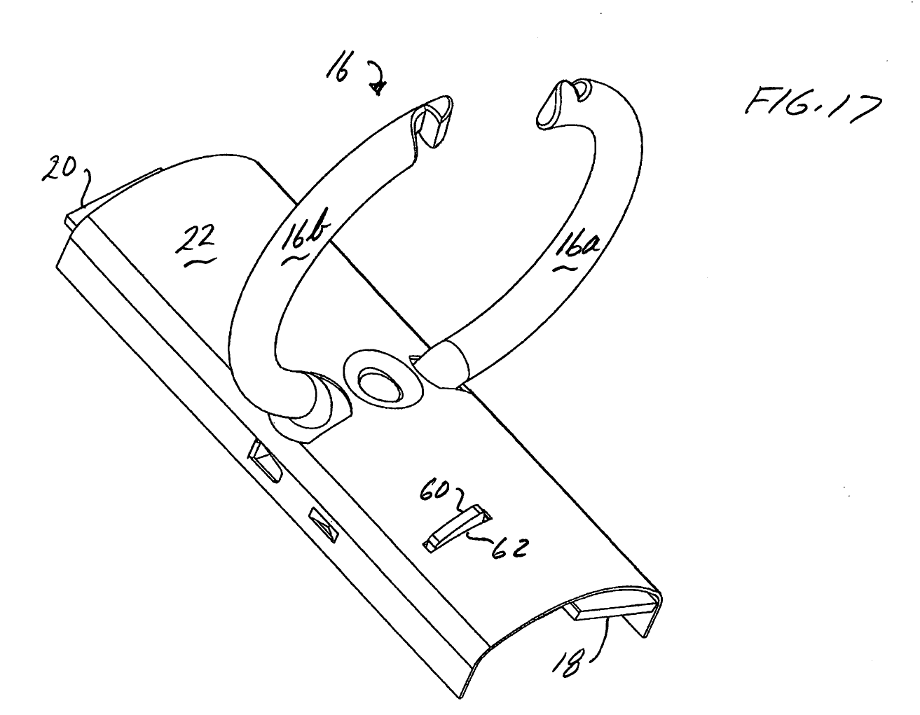

Next, as shown in FIG. 15, in another embodiment of the invention, a tab 60 is formed on, or attached to frame 20 adjacent binder ring half 16a. Now, a slot 62 is formed in cover 22 for tab 60 to extend through this slot when the frames 18 and 20 are pivoted to open the binder rings. Again it will be understood that a separate tab 60 is located adjacent each binder ring and that a slot 62 is formed in cover 22 adjacent the location of each tab 60; so that when the frames are pivoted to open the binder rings, the tabs 60 extend through the corresponding slots 62 formed in cover 22.

As with the construction of FIG. 14, the tab 60/slot 62 construction of FIG. 15 is such that so long as the binder rings remain open, longitudinal movement of frame 20 is prevented or blocked by the tabs 60 in the slots 62. Again, this maintains ring metal 10 in a binder ring open position. When the frames are rotated in the direction to close the binder rings, for the greatest portion of the rotation of the frames, a portion of the tabs 60 will extend through the slots 62 so to prevent longitudinal movement of frame 20. Again, this means the frame will only continue to rotate, not slide longitudinally. However, as the interlocking ends of the respective binder ring halves come into registry with each other, the tabs 60 clear the slots 62 so frame 20 can now move longitudinally in the direction for the interlocking ends of the binder ring halves to interfit with each other and close binder B.

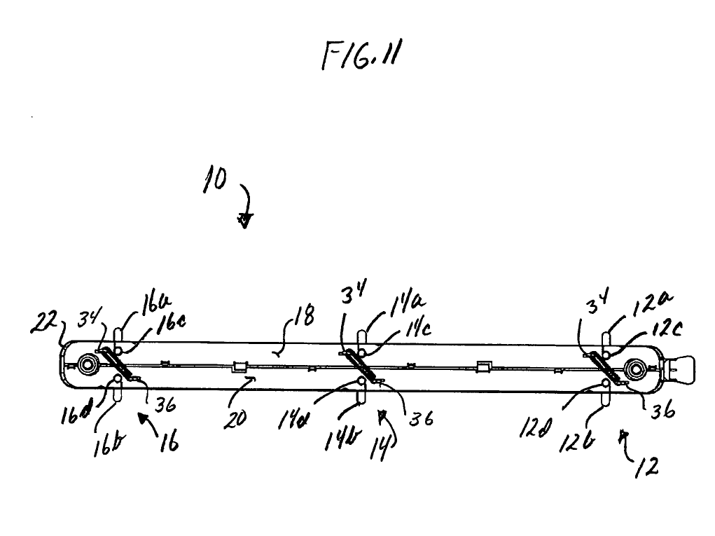

Finally, referring to FIG. 11, in an alternate embodiment of the invention, the springs 30a-30b are replaced with circular springs 60a-60c. These springs, rather than being connected to the ears 32 on the inside of the cover 22, instead are wrapped around the tabs 34 on frame 18 and the tabs 36 on frame 20. The springs 60a-60c operate similarly to the springs 30-30c in that once frame 20 has moved longitudinally with respect to frame 18, so the interlocking ends of the binder ring halves have separated, the springs force the frame to pivot in the direction to move these ends of the ring halves away from each other and open binder B.

With respect to the overall operation of ring binder B, the above described construction provides a binder in which the rings are positively locked in place when closed by the interlocking design of the rings, and cannot be inadvertently opened. Thus, even if the binder is knocked about or subjected to a significant force, the rings remain in their closed, locked position, and cannot be opened. Further, once the binder rings are open, they are readily held open until the user decides to close them.

In view of the above, it will be seen that the several objects and advantages of the present disclosure have been achieved and other advantageous results have been obtained.

Having thus described the invention, what is claimed and desired to be secured by Letters Patent is:

1. A locking ring metal for use in a ring binder comprising:
at least one twist-lok type binder ring comprised of a pair of binder ring halves with one end of each ring half interlocking with the corresponding end of the other ring half, when the binder ring is closed, to close the binder ring;
a pair of frames extending generally parallel to each other substantially the length of the metal with the other end of each ring half being attached to a respective one of the frames for pivotal movement of the frames relative to each other affecting opening of the binder ring; and,
means opening the binder ring including first moving one of the frames relative to the other frame to spatially separate the interlocking ends of the binder ring halves and unlock the binder ring, and then causing the frames to pivot in a binder ring opening direction.

2. The ring metal of claim 1 wherein one of the frames is movable longitudinally with respect to the other frame.

3. The ring metal of claim 2 in which the means opening the binder ring comprises a trigger installed at one end of the ring metal for movement of the trigger to move the movable frame relative to the other frame and separate the interlocking ends of the binder ring halves.

4. The ring metal of claim 3 further including a cover for the ring metal with the frames installed beneath the cover.

5. The ring metal of claim 4 wherein the means opening the binder ring further includes a spring the respective ends of which are secured to opposite sides of the cover on the underside of the cover below the frames, the spring exerting a force on the frames once the interlocking ends of the binder end halves are separated, to urge the frames to pivot in a binder ring opening direction.

6. The ring metal of claim 5 in which each frame includes a tab contacted by the spring for the spring to exert a force on the frame urging the frames in a binder ring open position.

7. The ring metal of claim 6 in which the spring is positioned adjacent the binder ring on the underside of the cover.

8. The ring metal of claim 7 further including a plurality of twist-lok type binder rings and a separate spring for each binder ring, each spring being positioned adjacent a respective binder ring on the underside of the cover.

9. The ring metal of claim 4 in which a slot is formed in a top surface of the cover through which upper portions of each binder ring half project with the slot for the binder ring half attached to the longitudinally movable frame being wider than the slot for the binder ring half attached to the other frame so the one binder ring half can move longitudinally with respect to the other binder ring half.

10. The ring metal of claim 9 in which, when the binder ring is open, the respective binder ring halves are offset, longitudinally, from each other.

11. The ring metal of claim 10 further including a tab extending downwardly from an underside of the cover toward the longitudinally movable frame.

12. The ring metal of claim 11 in which the longitudinally movable frame has a slot therein in which the tab is received when the binder ring is open to lock the longitudinally movable frame in place.

13. The ring metal of claim 12 in which, when the frames pivot to close the binder ring, the tab remains in the slot in the longitudinally movable frame until the interlocking ends of the binder ring halves are aligned for closing the binder ring.

14. The ring metal of claim 12 wherein the ring metal includes a plurality of binder rings and the ring metal further includes a tab extending downwardly from the underside of the cover adjacent each binder ring, and the movable frame has correspondingly located slots in which the respective tabs are received.

15. The ring metal of claim 10 further including a tab on the longitudinally movable frame and a slot formed in the cover through which the tab extends which the frames pivot to open the binder ring, for the tab to be received in the slot when the binder ring is open and lock the movable frame in place.

16. The ring metal of claim 4 wherein the means for opening the binder ring further includes a spring secured to the frames to exert a force on the frames urging the binder ring open.

17. The ring metal of claim 16 in which each frame includes a tab and the spring is a circular spring looped about the tabs with the force exerted by the spring on the frames urging the frames toward a binder ring open position once the interlocking ends of the binder ring are separated.

18. The ring metal of claim 17 in which the spring is positioned adjacent the binder ring.

19. The ring metal of claim 18 including a plurality of twist-lok type binder rings and a separate spring for each binder ring, each spring being installed on the frames adjacent a respective binder ring.

20. A locking ring metal for use in a ring binder comprising:
a plurality of twist-lok type binder rings spaced along the length of the metal, each binder ring comprising a pair of binder ring halves with one end of each ring half interlocking with the corresponding end of the other ring half, when the binder rings are closed, to close the respective binder rings;
a pair of frames extending generally parallel to each other substantially the length of the metal with the other end of each ring half of each binder ring being attached to a respective one of the frames for pivotal movement of the frames relative to each other affecting opening of the binder rings, one of the frames being movable longitudinally with respect to the other frame;
a cover for the ring metal beneath which the frames are installed;
a trigger installed at one end of the ring metal for movement of the trigger to move the movable frame relative to the other frame and separate the interlocking ends of the binder ring halves; and,
a spring the respective ends of which are secured to opposite sides of the cover on the underside of thereof below the frames, the spring exerting a force on the frames after the interlocking ends of the binder end halves are separated to urge the frames to pivot in a binder ring opening direction.

21. The ring metal of claim 20 in which each frame includes a tab contacted by each spring for the spring to exert a force on the frame, the force exerted by the spring urging the frames in a binder ring open position.

22. The ring metal of claim 21 further including a tab extending downwardly from the underside of the cover adjacent each binder ring with the movable frame having correspondingly located slots in which the respective tabs are received.

23. The ring metal of claim 22 in which, when the frames pivot to close the binder ring, the tabs remain in the slots in the longitudinally movable frame until the interlocking ends of the binder ring halves are aligned for closing the binder ring.

24. The ring metal of claim 20 further including a tab on the longitudinally movable frame and a slot formed in the cover through which the tab extends which the frames pivot to open the binder ring, for the tab to be received in the slot when the binder ring is open and lock the longitudinally movable frame in place.

25. A locking ring metal for use in a ring binder comprising:
a plurality of twist-lok type binder rings spaced along the length of the metal, each binder ring comprising a pair of binder ring halves with one end of each ring half interlocking with the corresponding end of the other ring half, when the binder rings are closed, to close the respective binder rings;
a pair of frames extending generally parallel to each other substantially the length of the metal with the other end of each ring half of each binder ring being attached to a respective one of the frames for pivotal movement of the frames relative to each other affecting opening of the binder rings, one of the frames being movable longitudinally with respect to the other frame;
a cover for the ring metal beneath which the frames are installed;
a trigger installed at one end of the ring metal for movement of the trigger to move the movable frame relative to the other frame and separate the interlocking ends of the binder ring halves; and,
a circular spring looped about a tab formed on each of the respective frames for the force exerted by the spring on the frames urging the frames toward a binder ring open position once the interlocking ends of the binder ring halves are separated.

26. The ring metal of claim 25 in which each spring is positioned adjacent a binder ring.

27. The ring metal of claim 25 further including a tab extending downwardly from the underside of the cover adjacent each binder ring with the movable frame having correspondingly located slots in which the respective tabs are received.

28. The ring metal of claim 27 in which, when the frames pivot to close the binder ring, the tabs remain in the slots in the longitudinally movable frame until the interlocking ends of the binder ring halves are aligned for closing the binder ring.

29. The ring metal of claim 25 further including a tab on the longitudinally movable frame and a slot formed in the cover through which the tab extends which the frames pivot to open the binder ring, for the tab to be received in the slot when the binder ring is open and lock the movable frame in place.

30. A locking ring metal for use in a ring binder comprising:
at least one twist-lok type binder ring comprised of a pair of binder ring halves with one end of each ring half interlocking with the corresponding end of the other ring half, when the binder ring is closed, to close the binder ring;
a first frame and a second frame with the other end of each ring half being attached to a respective one of the frames for pivotal movement of the frames relative to each other affecting opening of the binder ring, the first and second frames extending generally parallel to each other substantially the length of the metal, and one of the frames being movable relative to the other frame longitudinally of the ring metal;
a trigger connected to the longitudinally movable frame for movement of the trigger to move the movable frame relative to the other frame and separate the interlocking ends of the binder ring halves; and,
means affecting pivotal movement of the frames once the interlocking ends of the binder ring halves have separated for the frames to rotate in a binder ring opening direction.

31. A locking ring metal for use in a ring binder comprising:
at least one twist-lok type binder ring comprised of a pair of binder ring halves with one end of each ring half interlocking with the corresponding end of the other ring half, when the binder ring is closed, to close the binder ring;
a first frame and a second frame with the other end of each ring half being attached to a respective one of the frames for pivotal movement of the frames relative to each other affecting opening of the binder ring, the first and second frames extending generally parallel to each other substantially the length of the metal, and one of the frames being movable relative to the other frame longitudinally of the ring metal;
a trigger connected to the longitudinally movable frame for movement of the trigger to move the movable frame relative to the other frame and separate the interlocking ends of the binder ring halves; and,
means affecting pivotal movement of the frames once the interlocking ends of the binder ring halves have separated for the frames to rotate in a binder ring opening direction.

32. A locking ring metal for use in a ring binder comprising:
at least one twist-lok type binder ring comprised of a pair of binder ring halves with one end of each ring half interlocking with the corresponding end of the other ring half, when the binder ring is closed, to close the binder ring;
a first frame and a second frame with the other end of each ring half being attached to a respective one of the frames for pivotal movement of the frames relative to each other affecting opening of the binder ring, the first and second frames extending generally parallel to each other substantially the length of the metal, and one of the frames being movable relative to the other frame longitudinally of the ring metal;
means opening the binder ring including first moving the movable frame relative to the other frame to spatially separate the interlocking ends of the binder ring halves and unlock the binder ring, and then causing the frames to pivot in a binder ring opening direction; and,
means locking the movable frame in place once the frames have moved to their binder ring opening position by preventing longitudinal movement of the movable frame.

33. The locking ring metal of claim 32 further including a cover for the ring metal and the means locking the movable frame in place including a tab located on ob=ne of the movable frame or the cover and a slot formed on the other of the movable frame or slot, the tab being received in the slot as the movable frame pivots to the binder ring open position to block longitudinal movement of the movable frame.
